(19) United States
(12) Patent Application Publication
(10) Pub. No.: US 2024/0169387 A1
(43) Pub. Date: May 23, 2024

(54) Markdown and Lifecycle Management

(71) Applicant: The Boston Consulting Group, Inc., Boston, MA (US)

(72) Inventors: Roger FORCADA MARGARIT, Barcelona (ES); Jaume MUNTSANT SORIA, Barcelona (ES); Jens Johan Daniel ELIASSON, Stockholm (SE); Kriti SRIVASTAVA, London (GB); Xinghong MIAO, London (GB); Nicolas Peter GUELZOW, Bensheim (DE); Vahid RASHIDI, Ann Arbor, MI (US); Zijia XU, Hemel Hampstead (GB); Javier ANTA CALLERSTEN, London (GB); Stefano TODESCAN, Milano (IT); Sebastian BAK ADAMEK, Redondo Beach, CA (US); Marcus Johan Adam LIND, London (GB)

(21) Appl. No.: 17/989,063

(22) Filed: Nov. 17, 2022

(51) Int. Cl. G06Q 30/02; G06Q 10/08

(52) U.S. Cl. CPC G06Q 30/0223; G06Q 10/087

(57) ABSTRACT

Described is a markdown engine that allows for optimizing of an allocation of markdowns across plural levers. The markdown engine including instructions that configured a computer system to receive input data that includes historical and markdown scope information about the products and store, price information as well as stock, stock-out information, prepare the received input data into data structures. cluster the data structures according to product metrics into one or more clusters. For each of the one or more clusters the computer system is configured to determine a demand forecast according to a markdown plan for the one or more clusters, optimize the markdown plan with respect to one or more optimization goals and constraints for the one or more clusters, and output an optimized recommended set of markdowns for the one or more clusters.

### BACKGROUND

This invention relates to in-season promotions and markdowns.

Retailers use in-season promotions and markdowns to manage seasonal and perishable stock, which needs to be cleared out by the end of a season or before its expiration date. However, markdown and in-season promotions are generally determined using unscientific approaches that are not data-driven. This results in blanket promotions across an entire category of products or a set of stores or indeed a region of stores. These approaches lead to discounts that may be too deep, e.g., high discount relative to a more suitable discount. Too deep discounts erode a store's or indeed an entities profitability and may lead to out-of-stock warnings for some products and, at the same time, too shallow discounts for other products, leading to excess inventory at end of season and excess costs to clear the unsold inventory.

### SUMMARY

According to an aspect, a computer system includes a markdown engine that allows for optimizing of an allocation of markdowns across plural levers, the markdown engine including instructions that configured the computer system to receive input data that includes historical and markdown scope information about the products and store, price information as well as stock, stock-out information, prepare the received input data into data structures, cluster the data structures according to product metrics into one or more clusters; for each of the one or more clusters determine a demand forecast according to a markdown plan for the one or more clusters, optimize the markdown campaign plan with respect to one or more optimization goals and constraints for the one or more clusters, and output an optimized recommended set of markdowns for the one or more clusters.

One or more of the following embodiments or other embodiments disclosed herein may be included with the above aspect.

Instructions to cluster further includes instructions to determine quantifiable relationships in products and group products into the one or more clusters according to the quantifiable relationships.

The information to cluster products includes product class, product categories, and product metrics. The information is arranged in a vector defined by the product class, product categories, and product metrics. The instructions to cluster determine distances between vectors that represent a stock keeping unit.

The instructions further include instructions to cause the computer system to optimize proposed discounts sent from the demand forecast, by solving a mixed integer programming mathematical optimization that defines a target function to maximize as margin or margin penalized by leftover stock and defines a set of constraints that ensure that a solution found by the optimizer is applicable.

The instructions further include instructions to cause the computer system to re-optimize a current discount path for each stock keeping unit of a set of stock keeping units, based received deviations for the current discount path and received data regarding new sales of the set of stock keeping units.

The instructions further include instructions to cause the computer system to monitor performance of the markdown plan versus an initial version of the markdown plan and re-optimize the markdown plan when the optimizer determines that there is a deviation in the monitored performance versus the initial version of the markdown plan.

The instructions further include instructions to determine a demand forecast and for select items for picklist selection.

Other aspects include computer program products and computer implemented methods.

One or more of the above aspects may provide a markdown and lifecycle management tool that enables merchandisers to maximize margins by determining the right time and discount for every product including new products for which there is insufficient or no data. Given a set of input data, such as historical sales, prices, stock levels and costs, the markdown and lifecycle management tool provides an optimal discount path for each product including new products in order to maximize a pre-define business objective (e.g., margin maximization) while satisfying business and operational constraints to ensure applicability of proposed discounts.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data processing system.

FIG. 2 is a diagram depicting a markdown process.

FIG. 3 is a diagram depicting a clustering process useful in the markdown process of FIG. 2.

FIG. 4 is a diagram depicting the clustering process.

FIG. 5 is a diagram depicting demand forecast.

FIG. 6 is a diagram depicting an optimization.

FIG. 7 is a block diagram depicting a react engine.

FIG. 8 is a diagram depicting a react processing.

FIG. 9 is a diagram depicting a distributed computing environment implementation.

FIG. 10 is a diagram depicting a computer system.

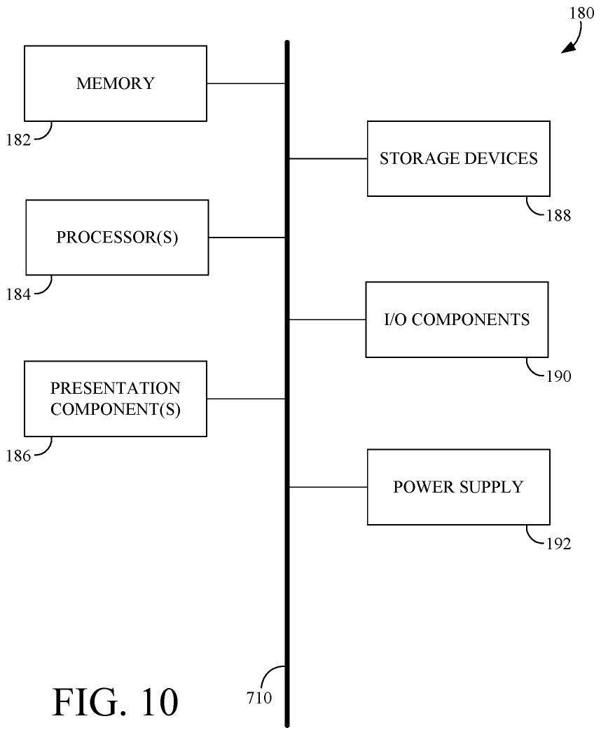

### DETAILED DESCRIPTION

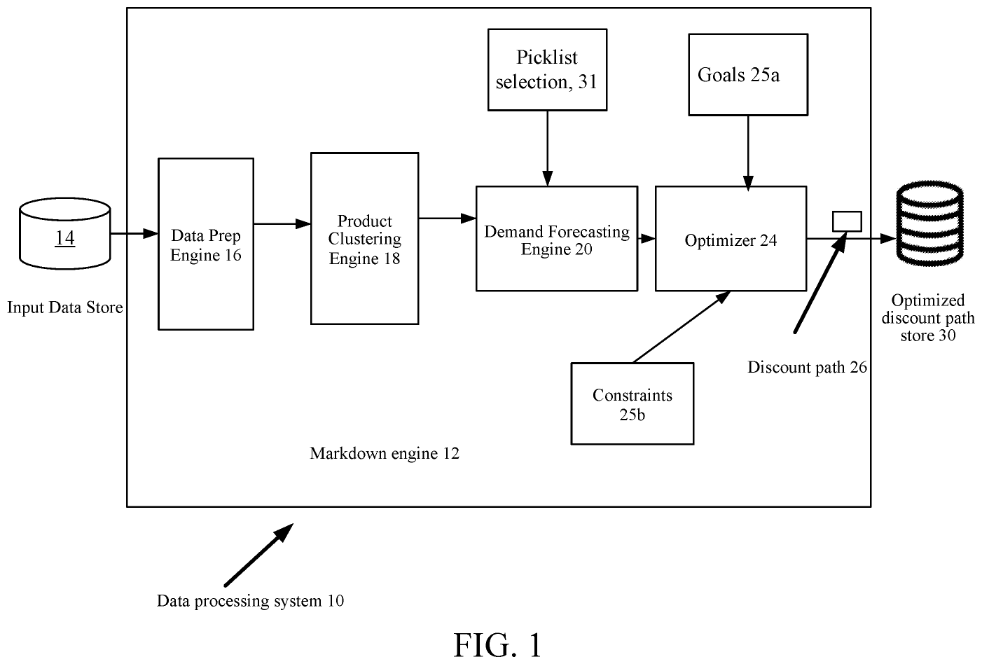

Referring now to FIG. 1, a data processing system 10 is shown. The data processing system 10 includes a markdown engine 12 and an input data store 14. The input data store 14 is a non-transitory hardware storage device that is either persistent, i.e., data remains when power is removed, or non-persistent, i.e., data is lost when power is removed. The input data store 14 has data that define “products” as product class and product metrics (e.g., product parameters). The markdown engine 12 converts the input data into or stores the input data into data structures 15. The data structures 15 include fields that have data product identifiers defined herein as product class and one or more fields for product metric. The markdown engine 12 provides an optimized allocation of recommended discounts, i.e., recommended markdowns across plural stock keeping units and, optionally stock keeping units and stores.

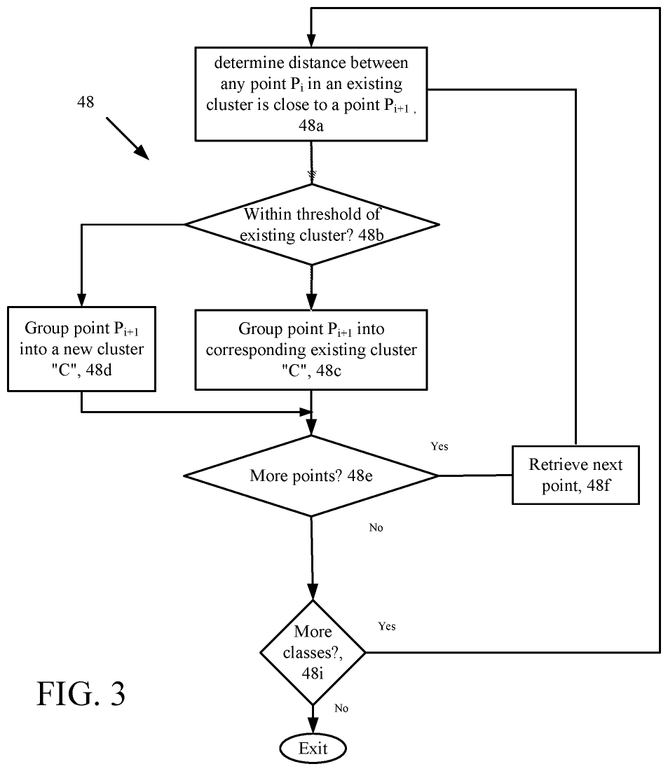

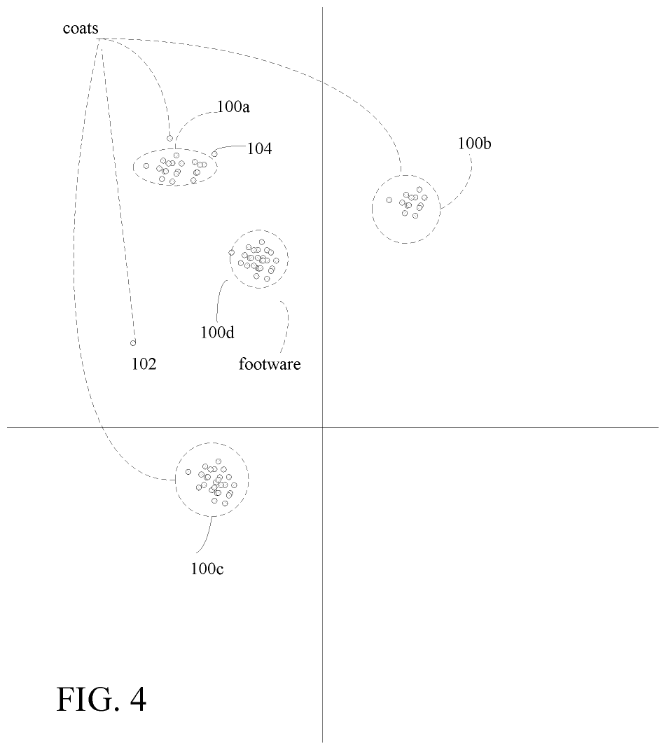

The markdown engine 12 also includes product clustering engine 18. The product clustering engine 18 receives the data structures 15 from the data preparation engine 16 and produces from the data structures 15 product clusters (See. FIGS. 3 and 4). The markdown engine 12 also includes a demand forecasting engine 20. The demand forecasting engine 20 receives a picklist selection 21 and produces a demand forecast based on the received picklist selection 21. The demand forecasting engine 20 is fed to an optimizer engine 24 that optimizes the demand forecast according to received goals 25a and constraints 25b, e.g., an available budget. The optimizer engine 24 produces from the demand forecast, the received goals 25a and the received constraints 25b, an optimized discount path 26 that is stored in discount path store 30, another non-transitory, hardware storage system. A picklist selection 21 is a listing of products to be included in the markdown.

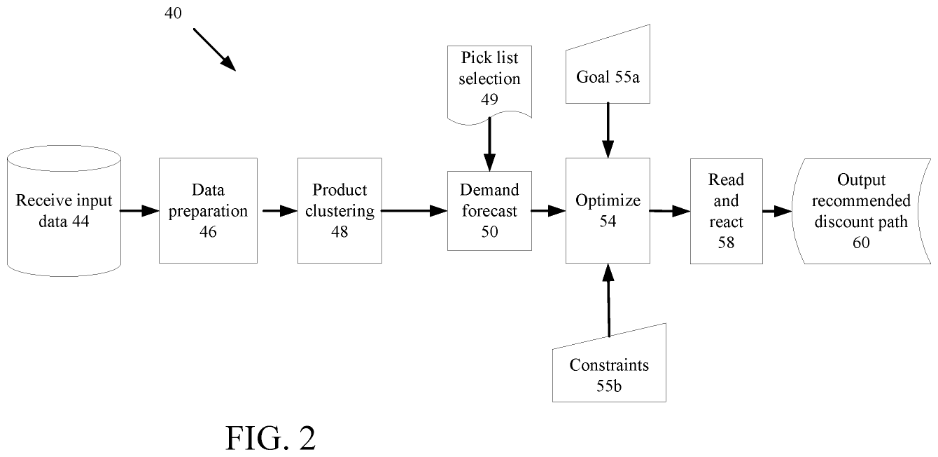

Referring now to FIG. 2, a markdown process 40 is shown. The markdown process 40 provides a full markdown past forecasting, instead of focusing on single promotion events. The markdown process 40 includes a three component, multiplicative approach for demand forecasting using a baseline process, an uplift process, and a boost process. The markdown process 40 also includes react logic that re-optimizes to full discount path after sales started.

The markdown process 40 includes receiving 44 input data from various sources. The markdown process 40 prepares 46 the received input data by loading the input data into suitable data structures. Examples of data structures are set out below:

The first data structure is a date store SKU (Table 1) that contains information about the products (both historical and markdown scope). The date store SKU also contains, store and price information as well as stock, stock-out and tax information. In the US, the tax information may be applicable according to states whereas, in the European Union, the tax information is the VAT for that country. Other countries will be similar to one or both of the above.

Table 1, the date store SKU table includes the following entries.

TABLE 1
date store SKU

| Columns: | |
|---|---|
| Field name | description |
| sku_id - STRING: | item id |
| department_name - STRING: | item department |
| category_name - STRING: | item category |
| sub_category_name - STRING: | item sub category |
| sku_name - STRING: | item name |
| date - DATE: | date |
| store_id - STRING: | store id |
| geo_region_name - STRING: | region name |
| country_name - STRING: | store country |
| revenue - FLOAT: | revenue |
| units_sold - INT: | number of units sold on this day |
| price_excluding_vat - FLOAT: | price excluding VAT |
| price_receipt - FLOAT: | price of the item on the receipt on |
| | this day |
| is_stockout - BOOL: | if the item was out of stock that day |
| unit_cost - FLOAT: | unit cost of the item |
| vat - FLOAT: | VAT |
| ingoing_stock - INT: | ingoing stock at a given date (stock |
| | at beginning of MD period required) |
| purchased_stock - INT: | initial stock values for products in scope |

Other tables include the following tables:

TABLE 2
Cost of Goods Sold (COGS)
The Cost of Goods Sold table is used to compute metrics such as
margin or penalized margin (2nd margin) and is used in the optimizer
cost constraint (not allowing items to be sold below cost).

| Columns: | |
|---|---|
| Field name | description |
| store_id - STRING: | store id |
| sku_id - STRING: | item id |
| COGS - FLOAT: | COGS value |

TABLE 3
Scope
A purpose of scope includes the combination of store-item that is
going to enter into the markdown optimization. The items in this table
will receive prices during execution of the markdown process 40.

| Columns: | |
|---|---|
| Field name | description |
| store_id - STRING: | store id |
| sku_id - STRING: | item id |

TABLE 4
discount
A purpose: discount skeleton. This table contains
the available discounts that can be used during the
markdown period. Should include all products in scope.

| Columns: | |
|---|---|
| Field name | description |
| store_id - STRING: | store id |
| sku_id - STRING: | item id |
| Discount - FLOAT: | potential discounts |

TABLE 5
Special days
A purpose: important dates associated to the stores (for both past and
future). It will be used in the forecast model, to improve prediction results.

| Columns: | |
|---|---|
| Field name | description |
| store_id - STRING: | store id |
| date - DATE: | date of the festivity (e.g: 31 Dec. 2022) |
| name - STRING: | name of festivity (e.g: New Year's Eve) |

TABLE 6
Penal values
A purpose: penalization factor to be applied to the cost for
computing the 2nd margin. The factor will be multiplied
to the remaining stock cost at the end the EOSS.

| Columns: | |
|---|---|
| Field name | description |
| store_id - STRING: | store id |
| sku_id - STRING: | item id |
| Penalty_factor - FLOAT: | penalty factorapplied on second margin |

TABLE 7
Boost features
A purpose: data used in Boost as external
regression factors (e.g. weather data, . . .)

| Columns: | |
|---|---|
| Field name | description |
| store_id - STRING: | store id |
| sku_id - STRING: | item id |
| Date - DATE: | date |
| [Boost features] | |

TABLE 8
Footfall
A purpose: traffic data used as a regression factor in the Uplift.
This way seasonality effects can be removed when computing the
elasticity. It can also be used in Boost to address events like COVID.

| Columns: | |
|---|---|
| Field name | description |
| store_id - STRING: | store id |
| Date - DATE: | date |
| Traffic - INT: | footfall information of the day |

Where footfall is defined as a number of persons entering a store or shopping area in a given time period, e.g., persons per hour, day, week, month, etc.

The markdown process 40 also includes product clustering 48 that outputs a markdown strategy for new products which have no sales history, as new transactions and inventory information becomes available. Product clustering 48 involves finding quantifiable relationships between products by understanding physical similarities and historical patterns.

The markdown process 40 also includes picklist selection 49 to determine which products to include. For example, the data processing system 10 analyzes and parses data items representing products to generate the list selection. These data items specify attributes of the products, such as lists of the potential attributes. To identify products to include in the list selection, the data processing system reads, from a hardware storage system, data structures representing rules specifying conditions, (defined in terms of attributes) to be satisfied for inclusion and/or a discount. Products are selected for discount, by descriptive features such as season, category and other attributes and performance such as selling speed, coverage weeks (stock/average sales), etc. For example, certain products will generally not be discounted whereas other products may be included in separate promotions. The markdown process 40 also includes demand forecast process 50 that strengthens relationships between clusters, detects promotion fatigue and accounts for seasonal changes and weather implications. The picklist selection 49 determines the articles to be included in the markdown process. The picklist selection 49 is an input to a demand forecast, which involves determining a sales volume forecast over time per discount.

The markdown process 40 also includes optimize process 54 to provide an optimal solution. Optimize process 54 takes into consideration a variety of parameters. Optimize process 54 provides a forecast per article, per store, at each discount level. Optimize process 54 uses a fully automated output that operates at a high level of granularity. With optimize process 54 complex problems can be solved over many permutations.

The markdown process 40 also includes a react process 58 that continuously learns and improves the markdown model. The markdown process 40 outputs 60 a list of prices and suggested discount paths, forecasted sales, profit and volume. React process 58 is used to significantly improved accuracy that allows a human input to calculate possible effects of possible constraints or to allow a user to overrule possible constraints.

Product Clustering

Product clustering finds and combines product similarities to predict demand for new and unseen products. Clustering determines quantifiable relationships in products, and groups products into clusters according to the strength of these relationships. Certain variables may be excluded, depending on user requirements. Clustering involves an advanced AI system discussed below that compares different elements from multiple products and takes a percentage-based similarity calculation to determine an overall cluster. Some of the relationships are based on product hierarchy, while others are based on physical properties and other factors.

Example information to cluster products include product class, product categories, product metrics, e.g., for the product class of footwear, material, (e.g., outer material/filling material) cover sole, outer sole, shape, heel height, color, size, etc. These product metrics are used in determine distances between points P, discussed below.

Referring now to FIG. 3, details on product clustering 48 are shown. Clustering is based on a variation of the K-nearest neighbors algorithm, where we find similar products based on categorical features (such as material, shape, color, etc.) See https://en.wikipedia.org/wiki/K-nearest_neighbors_algorithm for a discussion of the K-nearest neighbors algorithm. The the K-nearest neighbors algorithm is a supervised clustering algorithm.

As a generalized example of clustering, a point P is a vector defined by data for the product class. A point Pᵢ is a point in N-dimensional space that is defined by data including product class, category, outer material, filling, cover sole, outer sole, shape, heel height, color, size, style, etc. For this example, the point Pᵢ is a point that belongs to product class of “footwear.” A point Pₖ is an N-dimensional vector that is defined by data including product class, category, outer material, filling, color, size, style, etc. The point Pₖ belongs to product class of ‘coats.’

For the particular point Pᵢ in N-dimensional space, product clustering 48 determines 48a whether that point Pᵢ is close to another point Pᵢ₊₁ of the same product class, by determining the distance between those points as X=Pᵢ₊₁−Pᵢ in the N-dimensional space and compares 48b that distance X to a threshold value T_{footwear}. For the particular point Pₖ in N-dimensional space, product clustering 48 determines whether that point Pₖ is close to another point Pₖ₊₁ of the same product class, i.e., is not part of Pᵢ₊₁, by determining the distance between those points as Y=Pₖ₊₁−Pₗ in the N-dimensional space and compares that distance Y to a threshold value T_{coat}.

Determining the distance between those points uses description of products, e.g., web attributes to link to categories, price, materials, etc., as metrics for determining the distance and hence strength of a relationship between two points.

The product clustering 48 determines the distance X (here in two-dimensional space for illustration, but in practice, n-dimensional space). Each dimension in n-dimensional space corresponds to a dimension of the vector P and each of the n-dimensions corresponds to a metric, such as web attributes that link to categories, price, materials, etc., between all of the points, and groups them into the clusters, provided that the distance X is less than or equal to the threshold value, e.g., T_{footwear} or threshold value T_{coat} and that the product class of each point is the same.

As an example, the product clustering 48 determines 48a the distance X between a point Pᵢ₊₁ and any point in each existing cluster 48c, compares 48b that distance X to the threshold T and determines whether the point Pᵢ₊₁ belongs in the existing cluster 48c or whether the point Pᵢ₊₁ belongs in a new cluster 48d.

The product clustering 48 determines 48e whether there are more points. If so, the product clustering 48 retrieves 48f the next point and continues processing, as shown. On the other hand, if there are not any more points to cluster, the process may find 48g a centroid for each determined cluster. Finding a centroid involves finding a point that best represents the cluster, e.g., is at the center of the cluster or which is clustered around the predominant number of points in the cluster, using the K-nearest neighbors algorithm, as mentioned above.

Thus, the product clustering 48 groups points into clusters and from the cluster determines a centroid that is used to represent the points and all possible points in the cluster. Each cluster has associated with the cluster an identification of the product class. The centroid “D,” is the point P in N-dimensional space which, along with a determined tolerance, variance, or standard deviation, represents that particular cluster. These data are used to classify new products into clusters according to existing products and then these new products can be assigned markdowns. The product clustering 48 has non-missing, positive values for all three components of the demand forecasting to predict product demand and, thus, to assign markdowns. The product clustering 48 can check if there are more product classes 48i. If there are more product classes, the product clustering 48 returns to 48a and determines the distance for the next class. Each determined cluster is assigned a current discount.

Referring now to FIG. 4, there are provided three clusters pertaining to three different product classes of “footwear” and one cluster of pertaining to one product class of “coats.” In this very simplified example in two-dimensional space, there are four clusters, 100a-100d, a point 102, and a point 104. In this example, clusters 100a, 100b and 100c represent the product classes of objects referred to as “footwear”, whereas cluster 100d represents the product class of objects referred to as “coats.” The point 102 is an example of an outlier point that is of the class “footwear” and the point 104 is an example of an outlier point that is of the class “coat.”

While, the point 104 is close to the cluster of the class “footwear,” it actually belongs to the class of “coats” but is not included in either cluster “footwear” or “coats” since the distance between the point 104 and the nearest point in any of the clusters of “coats” is beyond the threshold “T_{coat}” for “coats’” Similarly, the point 102 is beyond the threshold “T_{footwear}” for “footwear” and is not included in any cluster. Both point 102 and point 104 are considered outliers or more correctly, noise in the data, and may be ignored or grouped manually. There can be another requirement for forming clusters, which is that the cluster has a minimum number of members. Generally, that number is determined empirically.

In addition, after processing of all points in the class, there may be some points that do not fit into any class. These outliers can be manually discounted.

Variations in the grouping are possible. For instance, the process has been described as involving determinations of clusters for each class of objects, sequentially. Thus, as described, a first class of objects are processed, clustered and represented as a centroid and a second class of objects are processed, clustered and represented as a centroid, and so forth. This need not be the case and instead objects from different classes can be processed and clustered, and the clusters can be represented as centroids that are identified by the class.

Picklist Selection

Picklist selection 49 determines the articles to be included in the markdown. Forecast inventory at end of an end of season sale (EOSS) for all seasonal and non-seasonal articles if no intervention made (under the assumption that the articles remain in current discount cluster). Prioritize SKUs with high inventory and high expected responsiveness to discounts. Work with business to finalize SKUs and compare with control stores. SKU is short for “stock keeping unit.” A SKU is generally an alphanumeric number that retailers assign to products to keep track of stock levels. If a product has different colors and sizes, each variation is assigned a unique SKU number. The granularity is defined by each client system.

Demand Forecast

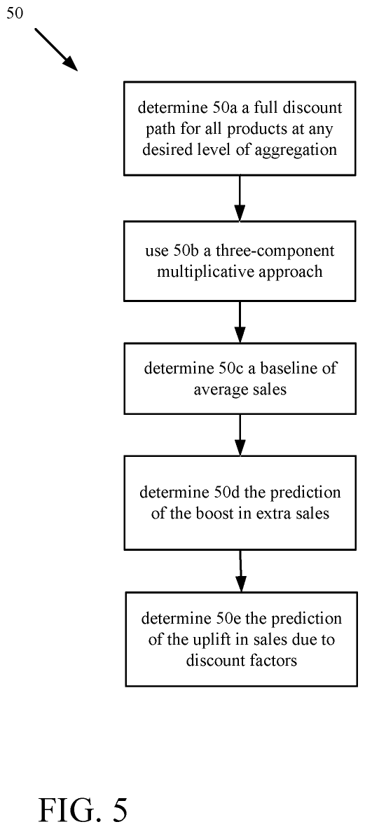

Referring now to FIG. 5 a demand forecast process 50 is shown. Demand forecast process 50 involves determining a prediction of a sales volume forecast over time per discount. A baseline is determined that is based on average sales on a normal trading day, excluding promos and holidays. Boost is calculated as a prediction of extra sales in percent (%) due to non-discount factors. Uplift is calculated as a prediction of extra sales in percent (%) due to discount factors.

Baseline

The baseline is the scale-setting part of the predictive model. Baseline derives from the idea that the single best predictor of an item's sales tomorrow is how many that item sold today. The intuitive interpretation of the baseline is how many units you would expect to sell of that item in that store on a typical day of sales at the typical price. In broad terms, the baseline is an estimate of the average daily sales of an item over some appropriate range of the recent past. Almost all the rest of the module handles edge cases, such as the following:

Baseline corrects for items that have not recently sold at the typical price. Removes special dates (like bank holidays or special promotions dates) based on user input in the special dates data. Removes stock-out dates based on user input in the stock-out table. The markdown process 40 is to be used with products that have been sold during the full season.

If a client customer adds new or relatively new products to a markdown process, baseline computation is likely to fail without a mechanism to handle new products. That is, baseline needs to run, at least, every time the execution date is changed. However, see product clustering 48, discussed above, that is used in the markdown process 40 to output a markdown strategy even for new products with no sales history.

Uplift

Uplift describes the price elasticity of an item: how much its demand changes as its price is raised or lowered. Uplift is assumed to have a multiplicative effect. For example, a certain change in price may raise demand for a product by 20% over its baseline value rather than increasing it by, say, 5 units per day. As a result, uplift is a dimensionless number between 0 and infinity, with a value of 1 indicating no particular uplift over the baseline demand. The uplift is essentially defined to be 1 at the typical discount at which the baseline is calibrated. Uplift is computed by assessing what are the growths in unit sold, depending on price change. This historical record is fitted to a mathematical curve (typically exponential). Uplift is computed using previous markdown seasons. The uplift module need only be executed once for each campaign.

Boost

Boost is the term for all of the non-price drivers of sales: typically, all of the periodic or event-driven events that may hinder or help the sales in a store. Examples of these include: weekly sales trends that may show that weekend traffic (and thus sales) is 20% higher than what is seen during weekdays, annual patterns that may show an overall drop in sales volumes during August but more sales in December. Other examples include holidays that might show elevated sales in the days leading into Christmas, low sales on Christmas itself, and extremely high sales on the two days after Christmas. Other examples include events like voucher promos or center-wide events that also drive sales. These sales can be modeled using Autoregressive integrated moving average (ARIMAX) framework, (see https://en.wikipedia.org/wiki/Autoregressive_integrated_moving_average) where the “I” term allows for the possibility of long-term, organic growth of the business, the “X” terms allow us to specify external drivers (like holidays and other special events) that may occur at any time of the year, the “AR” and “MA” terms both account for the weekly/seasonal patterns as well as the multi-day effects that certain holidays and events may cause.

Regression factors can be added by providing a list in features. The user needs to prepare data in the training and prediction data at the aggregation level for boost. It is essential that the regression factor is available in the prediction time frame, so a regression factor for which future values are not available or cannot be estimated should not be used as a regression factor.

Demand forecast process 50 has the data processing system 10 determine 50a all discount options for all products at any desired level of aggregation. By all discount options is meant that the demand forecast process 50 rather than calculating explicitly all discount paths, the demand forecast process 50 calculates all possible discount steps (e.g., 10%, 20%, . . . ) at each update period. An update period is a discretization of the time on the moments that prices are allowed to change. Thus, the number of options calculated corresponds to the number of discount steps times the number of update periods.

As opposed, if a process was calculating full discount paths the process would need a number of discount options raised to the number of update periods) which is significantly large. Demand forecast process 50 has the data processing system 10 potentially, allows a different discount path for each SKU-Store. Demand forecast process 50 has the data processing system 10 use 50b a three-component multiplicative approach. Demand forecast process 50 has the data processing system 10 determine 50c a baseline of average sales on a normal trading day. Demand forecast process 50 has the data processing system 10 determine 50d the prediction of the boost in extra sales due to non-discount factors, such as relevant calendar dates, weekends, or other factors such as marketing campaigns. Demand forecast process 50 has the data processing system 10 determine 50e the prediction of the uplift in sales due to discount factors. Baseline defines the level of the demand and serves as a scaling factor to adapt the forecast to the recent past. Boost models non-price drivers, tracking seasonality of products and defining the overall shape of sales in time. Uplift models the contribution in demand of price drivers, allowing to simulate incremental sales at different discount points.

Scenario Generation

Scenario generation is optional and involves that within set business boundaries, all permutations of discounts and pricing paths are assessed. Within business boundaries revenue or cash margin uplift based on business goals, and all possible store-item group price paths are generated. The markdown process 40 does not need an explicit calculation of all scenarios (i.e., price paths). The optimization process 54 discussed below can find an optimal price path, without need to explicitly calculate all alternatives. However, a scenario generation module may be used to show client customers why other alternative scenarios were inferior to the optimal path chosen path.

Optimization

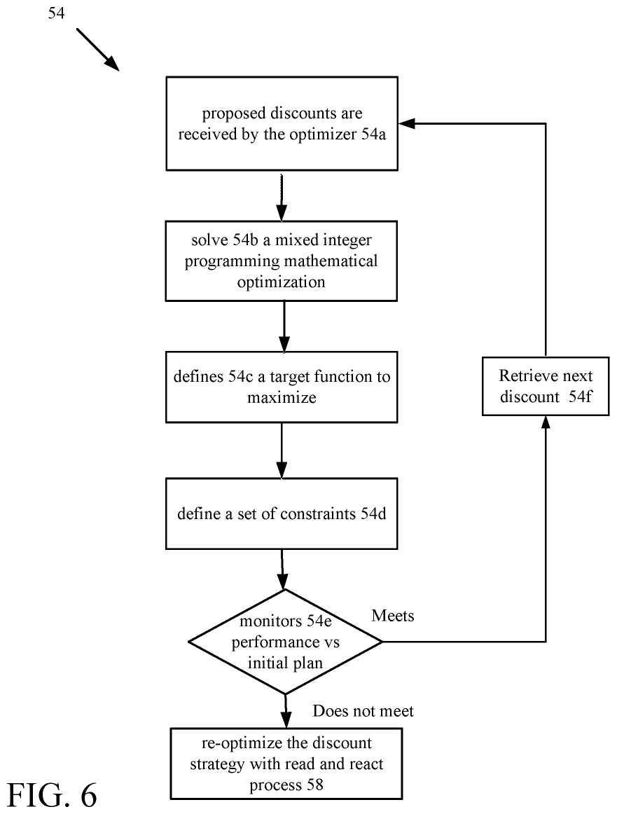

Referring now to FIG. 6, an optimize process 54 is shown. The optimize process 54 cuts through typical intractable complexity to provide an optimal solution, by de-averaging total forecast into store level forecasts, while applying store and size stock constraints to calculate a ‘realistic’ demand. The optimize process 54 synthesizes all effects and executes simulation in many scenarios, and performs inter-article trade-offs to achieve a specified goal. The optimizer takes into consideration a variety of parameters. The optimizer provides a forecast per article, per store, at each discount level, stores level stock by article and cannibalization and complementarity to rest of categories. Constrains the forecast with store stock, maps out all possible discount routes and commercial scenarios and iterates through all possible routes to find an optimal scenario. The optimize process 54 finds an optimal path to maximize the financial outcome while complying with the defined set of business constraints.

The optimize process 54 receives 54a from the demand forecast process 50 sends proposed discounts. The optimize process 54 optimizes the proposed discounts by solving 54b a mixed integer programming mathematical optimization. The objective of the optimization is to maximize benefit during the markdown campaign. This means, that the optimal discounts can be written as:

$${d}^{\dot{\hat{}}} = argmax {{{\sum }_{s ϵ S}}_{i ϵ I}}_{p ϵ P} {K}_{s , i , p} \qquad Eq . 1$$

Where s is the selected store, i is the selected item and p is the selected discount period. K represents the business parameter to maximize. Given that this problem is discrete (the price selected to each of the products is not a continuous variable), a MIP solver is used to solve Eq. 1. This problem can be proved to be non-linear. Given this property, the MIP solver is needed to modify the formulation.

$${d}^{\dot{\hat{}}} = argmax {{{{\sum }_{s ϵ S}}_{i ϵ I}}_{p ϵ P}}_{d ϵ D} {B}_{s , i , p , d} {K}_{s , i , p , d} \qquad Eq . 2$$

Where B is a binary variable and d are all possible discounts. With this formulation, to the MIP solver generates all possible combinations and then restricts the Binary variable to be 1 in the selected scenario and 0 in those that are not optimal. This way the formulation becomes linear. The initial problem size is the product of the number of stores, number of items, number of periods and number of possible discounts.

For additional information on mixed integer programming please see “https://www.gurobi.com/resource/mip-basics/.’ The mixed integer programming mathematical optimization defines 54c a target function to maximize (typically margin or margin penalized by leftover stock but can be tailored to clients' needs) and define a set of constraints 54d that ensure that the solution found by the optimizer is applicable. Some constraints are purely instrumental to define the markdown problem (such as enforcing non-increasing prices over time), while others allow business users to input their strategy to satisfy some business or operational requirements (such as imposing a limit on the number of re-tags on a given week).

Once promotions go live in the stores, the optimizer monitors 54e performance of the optimized markdown plan. When the optimizer determines that there is a deviation in the monitored performance vs the un-optimized version of the markdown campaign plan the deviation is fed to the react process 58, which attributes the deviation to each of the components of the demand forecast, resulting in updated baseline, uplift, and boost values for each SKU (or any level of aggregation defined).

Optimization Constraints

The following constraints are commonly used during optimization. Selected price should be above cost: selects a price paths where all discounted prices are above cost. The result will be infeasible if there are not available discounts that allow the price to be below cost. Stores should share the same price: all stores belonging to the same store group should have the same prices for the same items. Price monotony: prices can only go down (or maintain) during the markdown campaign, per product. Minimum and maximum sell through: select a percentage of the purchased stock that should remain (or should be sold) during the markdown campaign. Minimum and maximum average discount: compute the average of all discounts and forces it to be above or below a certain value. Minimum discount increase: configure a minimum step increase of discounts, by product, for each of the update periods. Maximum number of retags: configure a maximum number of item retags applied to all stores for each of the update periods.

React

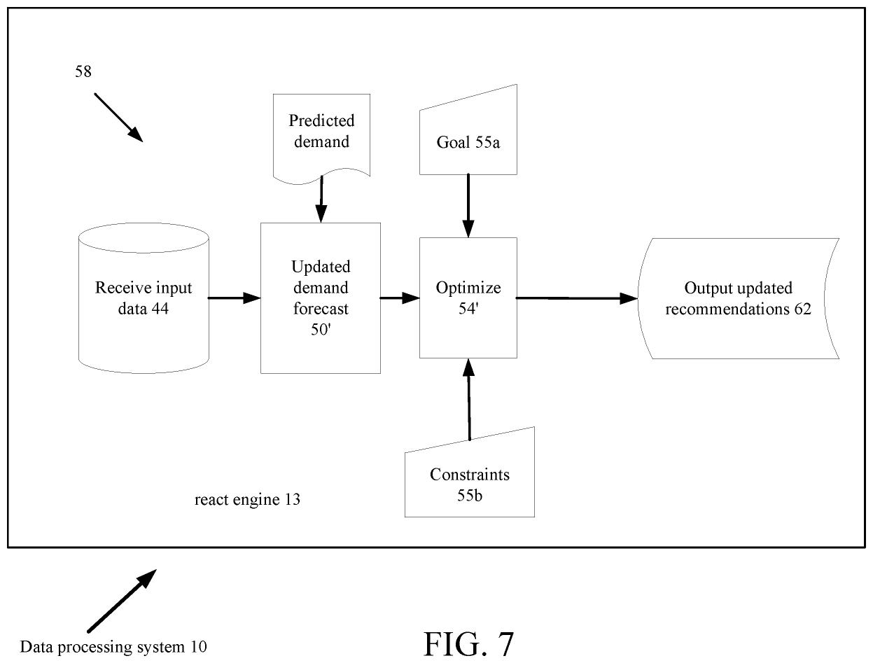

Referring now to FIG. 7, the data processing system 10 is shown with a react engine 13 that is included in the markdown engine 12, together with the input data store 14. The input data store 14 is a non-transitory hardware storage device that is either persistent, i.e., data remains when power is removed, or non-persistent, i.e., data is lost when power is removed. The input data store 14 has data that define “products” as product class and product metrics (e.g., product parameters), as in FIG. 1. The react engine 13 provides the clusters (see FIG. 3 or FIG. 4) to an updated demand forecast engine 50′. The demand forecasting engine 50′ receives predicted demand and produces an updated demand forecast based on the predicted demand. The updated demand forecast is fed to optimizer 54′ that optimizes the updated demand forecast according to received goals 55a and constraints 55b, e.g., an available budget and outputs an updated set of recommendations 62.

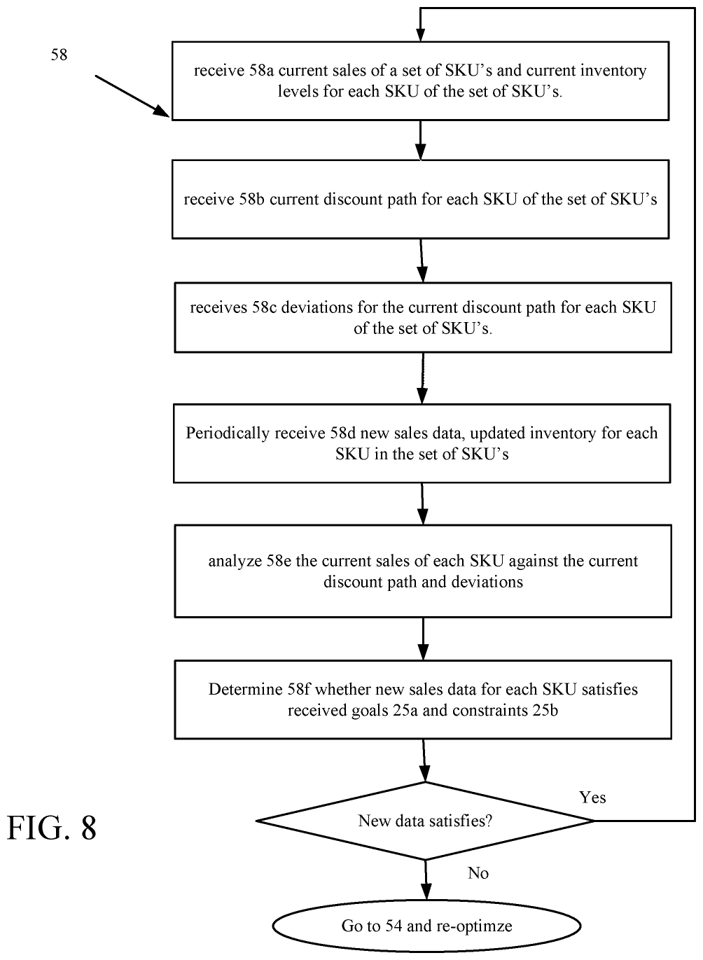

The react engine 13 continuously learns and improves the discounts. A react process 58 (FIG. 8) also re-optimizes a discount path after sales have started, as new transactions and inventory information become available. React process 58 re-optimizes the markdown plan once started.

Referring now to FIG. 8, details of the react process 58 are shown. The react process 58 has the data processing system 10 receive 58a current sales of a set of SKU's, current inventory levels for each SKU of the set of SKU's. The react process 58 also has the data processing system 10 receive 58b current discount path for each SKU of the set of SKU's and receives original forecasted sales for the selected discount path, and calculates the deviation from the actual sales. The react process 58 has the data processing system 10 periodically receives 58e data regarding new sales of the set of SKU's the current inventory levels for each SKU of the set of SKU's, the current discount path for the set of SKU's and the deviations.

The react process 58 has the data processing system 10 analyze 58e the current sales of each SKU of the set of SKU's against the current discount path for each SKU of the set of SKU's and determines 58e whether each SKU is satisfying the received goals 55a and constraints 55b. The react process 58 determines 58f whether each SKU of the set of SKU's satisfies the received goals 55a and constraints 55b. When the react process 58 has the data processing system 10 determine that the received goals 55a and constraints are satisfied, the react process 58 continues to periodically receive the data regarding new sales of the set of SKU's, updated inventory levels for each SKU of the set of SKU's, and the current discount path for the set of SKU's. When the react process 58 has the data processing system 10 determine that the received goals 55a and constraints are not satisfied, the react process 58 re-optimizes 58i by re-executing the optimize process 54 for the discount path for the set of SKU's by determining a new, updated discount path for the set of SKU's.

Thus, once markdown campaign start, the react process 58 observes real sales for those SKUs and uses a calculated deviation to improve future decisions (markdowns). The react process 58 calculates a controlled deviation ratio based on recent data and calculate deviation contribution to baseline and uplift. The react process 58 uses contributions to scale and shape next recommendations.

Allocation of the contributions is done by splitting between non-price and price drivers of the demand forecasting model. At a given discount level, forecast can be split by two levers non-price drivers that cover baseline plus boost components of the markdown process 40 (sometimes summarized as “baseline,”), reflecting what would have sold without any discount at this given date and price drivers, which covers uplift in the markdown process 40, reflecting how much of the sales were expected to come by the selected discount.

Baseline share=% of the sales coming from the non-price drivers at observed % discount.

Uplift share=% of the sales coming from the price drivers at observed % discount

Baseline contribution=Bias×Baseline share

Uplift contribution=Bias×Uplift share

Bias is an observed bias based on a lookback period. Two parameters can control the speed or reaction to the observed bias.

Lookback period, which is the period that is chosen to measure the bias between locked plan in the system and actual sales figures.

Confidence value in lookback period, which is a percentage of the observed bias to be corrected using react process 58.

Output

The output includes recommend discounts, in a format that can be plugged directly to a client's pricing system and business parameters such as unit sales, revenue, margin projections. So, a business can compare several runs of the tool and select the strategy more appropriate to the business' needs.

The markdown process 40 also includes promotion fatigue processing 41 that accounts for a decline in demand when products are on promotion for extended periods of time. The described approach predicts full discount path for all SKU's at any desired level of aggregation (potentially, allowing a different discount path for each SKU—Store combo). This allows a customer to plan a markdown strategy in advance, for all retags, instead of focusing on a single markdown/promotion event.

### Example Distributed Computing System Environment

Referring now to FIG. 8, an example of a distributed computing environment 150 is shown. FIG. 8 shows a high-level architecture of a cloud computing platform 152 that can host a technical solution environment, or a portion thereof (e.g., a data trustee environment). It should be understood, that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The distributed computing environment 150 includes data centers that includes cloud computing platform 152, rack 154, and node 156 (e.g., computing devices, processing units, or blades) in rack 154. The technical solution environment can be implemented with cloud computing platform 152 that runs cloud services across different data centers and geographic regions. Cloud computing platform 152 can implement fabric controller 158 component for provisioning and managing resource allocation, deployment, upgrade, and management of cloud services. Typically, a cloud computing platform 152 acts to store data or data analytics applications in a distributed manner. Cloud computing platform 152 in a data center can be configured to host and support operation of endpoints of a particular service application. Cloud computing platform 152 may be a public cloud, a private cloud, or a dedicated cloud.

Node 156 can be provisioned with host 160 (e.g., operating system or runtime environment) execution a defined software stack on node 156. Node 156 can also be configured to perform specialized functionality (e.g., compute nodes or storage nodes) within cloud computing platform 152. Node 156 is allocated to run one or more portions of a service application of a tenant. A tenant can refer to a customer utilizing resources of cloud computing platform 152. Service application components of cloud computing platform 152 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 156, nodes 156 may be partitioned into virtual machines (e.g., virtual machine 162 and virtual machine 164). Physical machines can also concurrently run separate service applications. The virtual machines or physical machines can be configured as individualized computing environments that are supported by resources 166 (e.g., hardware resources and software resources) in cloud computing platform 152. It is contemplated that resources can be configured for specific service applications. Further, each service application may be divided into functional portions such that each functional portion is able to run on a separate virtual machine. In cloud computing platform 152, multiple servers may be used to run data analytics applications and perform data storage operations in a cluster. In particular, the servers may perform data operations independently but exposed as a single device referred to as a cluster. Each server in the cluster can be implemented as a node.

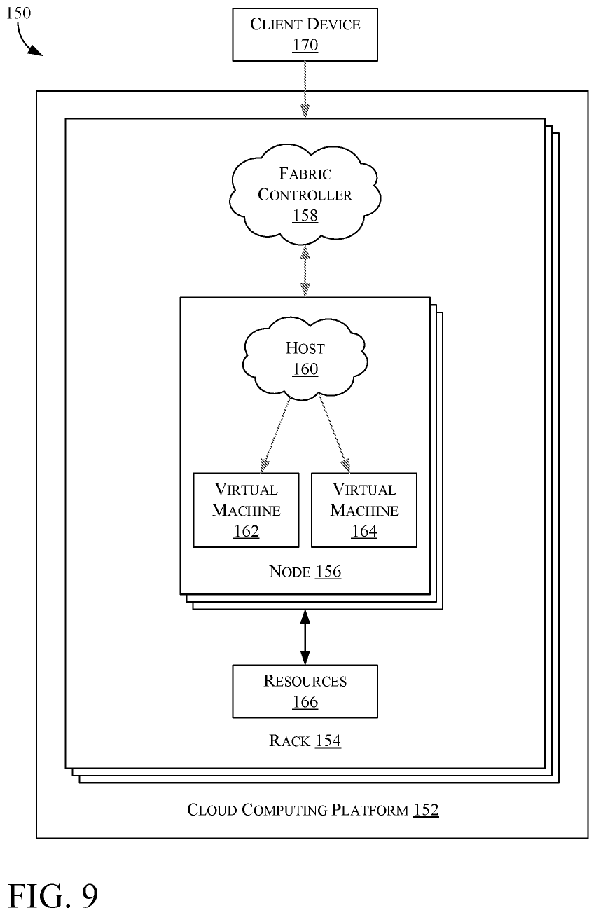

Client device 170 may be linked to a service application in cloud computing platform 152. Client device 170 may be any type of computing device, which may correspond to computing device 180 described with reference to FIG. 9, for example, client device 170 can be configured to issue commands to cloud computing platform 152. In embodiments, client device 170 may communicate with data analytics applications through a virtual Internet Protocol (IP) and load balancer or other means that direct communication requests to designated endpoints in cloud computing platform 152. The components of cloud computing platform 152 may communicate with each other over a network (not shown), which may include, without limitation, one or more local area networks (LANs) and/or wide area networks (WANs).

### Example Computing Environment

Referring to FIG. 9, an example operating environment for implementing embodiments of the present invention is shown and designated generally as computing device 180. Essential elements of a computing device 180 or a computer or data processing system, etc. are one or more programmable processors 184 for performing actions in accordance with instructions and one or more memory devices 182 for storing instructions and data. Generally, a computer will also include, or be operatively coupled, (via bus, fabric, network, etc.,) to I/O components 190, e.g., display devices, network/communication subsystems, etc. and one or more mass storage devices 188 for storing data and instructions, etc., which are powered by a power supply 192.

The features of the markdown improve the functioning of the distributed computing environment and/or the computing device (or computer or data processing system, etc.) by providing the markdown and lifecycle management tool that enables the computing device to maximize margins for every merchant product including new products.

Embodiments can be implemented in digital electronic circuitry, or in computer hardware, firmware, software, or in combinations thereof. Embodiments can be implemented in a computer program product tangibly stored in a machine-readable (e.g., non-transitory computer readable) hardware storage device for execution by a programmable processor; and method actions can be performed by a programmable processor executing a program of executable computer code (executable computer instructions) to perform functions of the invention by operating on input data and generating output. Embodiments can be implemented advantageously in one or more computer programs executable on a programmable system, such as a data processing system that includes at least one programmable processor coupled to receive data and executable computer code from, and to transmit data and executable computer code to, memory, and a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive executable computer code (executable computer instructions) and data from memory, e.g., a read-only memory and/or a random-access memory and/or other hardware storage devices. Generally, a computer will include one or more mass storage devices for storing data files; such devices include magnetic disks, such as internal hard disks and removable disks; magneto-optical disks; and optical disks. Hardware storage devices suitable for tangibly storing computer program executable computer code and data include all forms of volatile memory, e.g., semiconductor random access memory (RAM), all forms of non-volatile memory including, by way of example, semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

A number of embodiments of the invention have been described. The embodiments can be put to various uses, such as educational, job performance enhancement, e.g., sales force and so forth. Nevertheless, it will be understood that various modifications may be made without departing from the scope of the invention.

1. A cloud computing platform comprising:
a plurality of computing nodes, wherein each of the plurality of computing nodes comprises a host and one or more virtual machines; and
a fabric controller configured to provision resources to the plurality of computing nodes,
wherein the plurality of computing nodes are configured to optimize an allocation of markdowns for one or more products, and wherein the plurality of computing nodes store instructions that, when executed by one or more processors of the plurality of computing nodes, cause the plurality of computing nodes to perform operations comprising:
receiving, from a hardware storage device, input data comprising:
historical and markdown scope information regarding the one or more products and one or more stores selling the one or more products,
price information regarding the one or more products and the one or more stores, and
stock and stock-out information regarding the one or more products and the one or more stores;
generating a plurality of data structures based on the received input data;
clustering, using an artificial intelligence (AI) system, the data structures according to product metrics into a plurality of clusters, wherein clustering the data structures comprises:
determining, by the AI system, a plurality of points in N-dimensional space based on the data structures,
determining, by the AI system, distances between respective pairs of the points,
comparing, by the AI system, the distances to a threshold value,
generating, by the AI system, the plurality of clusters based on the distances,
determining, by the AI system, a respective centroid for each of the plurality of clusters, and
classifying, by the AI system, one or more additional products into the plurality of clusters based on the centroids; and
for each of the one or more clusters:
determining a demand forecast according to a markdown plan for the one or more clusters;
optimizing the markdown plan with respect to one or more optimization goals and constraints for the one or more clusters, wherein optimizing the markdown plan comprises performing a mixed integer programming mathematical optimization process with respect to a target function, wherein the target function represents margin penalized by leftover stock; and
generating and storing, using the hardware storage device, an optimized recommended set of markdowns for the one or more clusters.

2. The computer system of claim 1 wherein clustering the data structures comprises:
determining quantifiable relationships between the one or more products; and
grouping the one or more products into the one or more clusters according to the quantifiable relationships.

3. The computer system of claim 1 wherein clustering the data structures comprises:
clustering the data structures based on product information regarding product classes, product categories, and product metrics of the one or more products.

4. The computer system of claim 3, wherein the product information is arranged in a vector defined by the product classes, product categories, and product metrics.

5. The computer system of claim 1, wherein clustering the data structures comprises:
determining distances between vectors that represent a stock keeping unit.

6. The computer system of claim 5, wherein the mixed integer programming mathematical optimization process defines a set of constraints that ensure that a solution found by an optimizer is applicable.

7. The computer system of claim 6, wherein the operations further comprise
re-optimizing a current discount path for each stock keeping unit of a set of stock keeping units, based on received deviations for the current discount path and received data regarding new sales of the set of stock keeping units.

8. The computer system of claim 1, wherein the operations further comprise:
monitoring performance of the markdown plan an initial version of the markdown plan; and
re-optimizing the markdown plan when an optimizer determines that there is a deviation in the monitored performance versus the initial version of the markdown plan.

9. The computer system of claim 1, the operations further comprising:
determining a list of products to be included in the markdown plan.

10. A computer implemented method comprising:
accessing a cloud computing platform comprising:
a plurality of computing nodes, wherein each of the plurality of computing nodes comprises a host and one or more virtual machines, and
a fabric controller configured to provision resources to the plurality of computing nodes; and
optimizing, using the plurality of computing nodes, an allocation of markdowns for one or more products, wherein optimizing the allocation of markdowns comprises:
receiving, from a hardware storage device, input data comprising:
historical and markdown scope information regarding the one or more products and one or more stores selling the one or more products, price information regarding the one or more products and the one or more stores, and
stock and stock-out information regarding the one or more products and the one or more stores;
generating a plurality of data structures based on the received input data;
clustering the data structures according to product metrics into one or more clusters, wherein clustering the data structures comprises:
determining a plurality of points in N-dimensional space based on the data structures,
determining distances between respective pairs of the points, and
comparing the distances to a threshold value;
for each of the one or more clusters:
determining a demand forecast according to a markdown plan for the one or more clusters;
optimizing the markdown plan with respect to one or more optimization goals and constraints for the one or more clusters, wherein optimizing the markdown plan comprises performing a mixed integer programming mathematical optimization process with respect to a target function, wherein the target function represents margin penalized by leftover stock; and
generating and storing, using the hardware storage device, an optimized recommended set of markdowns for the one or more clusters.

11. The computer implemented method of claim 10, wherein clustering the data structures comprises
determining quantifiable relationships between the one or more products; and
grouping the one or more products into the one or more clusters according to the quantifiable relationships.

12. The computer implemented method of claim 10, wherein clustering the data structures comprises:
clustering the data structures based on product information regarding product classes, product categories, and product metrics of the one or more products.

13. The computer implemented method of claim 12, wherein the product information is arranged in a vector defined by the product classes, product categories, and product metrics.

14. The computer implemented method of claim 10, wherein clustering the data structures comprises:
determining distances between vectors that represent a stock keeping unit.

15. The computer implemented method of claim 14, wherein the mixed integer programming mathematical optimization process defines a set of constraints that ensure that a solution found by an optimizer is applicable.

16. The computer implemented method of claim 15, further comprising:
re-optimizing a current discount path for each stock keeping unit of a set of stock keeping units, based on received deviations for the current discount path and received data regarding new sales of the set of stock keeping units.

17. The computer implemented method of claim 10, further comprising:
monitoring performance of the markdown plan versus an initial version of the markdown plan; and
re-optimizing the markdown plan when an optimizer determines that there is a deviation in the monitored performance versus the initial version of the markdown plan.

18. A computer program product tangibly stored on a non-transitory computer readable medium, the computer program product including instructions that, when executed by one or more processors, cause the one or more processors to perform operations comprising:
accessing a cloud computing platform comprising:
a plurality of computing nodes, wherein each of the plurality of computing nodes comprises a host and one or more virtual machines, and
a fabric controller configured to provision resources to the plurality of computing nodes; and
optimizing, using the plurality of computing nodes, an allocation of markdowns—for one or more products, wherein optimizing the allocation of markdowns comprises:
accessing a cloud computing platform comprising:
a plurality of computing nodes, wherein each of the plurality of computing nodes comprises a host and one or more virtual machines, an
a fabric controller configured to provision resources to the plurality of computing nodes; and
receiving, from a hardware storage device, input data comprising:
historical and markdown scope information regarding the one or more products and one or more stores stilling the one or more products
price information regarding the one or more products and the one or more stores, and
stock and stock-out information regarding the one or more products and the one or more stores;
generating a plurality of data structures based on the received input data;
clustering the data structures according to product metrics into one or more clusters, wherein clustering the data structures comprises:
determining a plurality of points in N-dimensional space based on the data structures,
determining distances between respective pairs of the points, and comparing the distances to a threshold value;
for each of the one or more clusters:
determining a demand forecast according to a markdown plan for the one or more clusters;
optimizing the markdown plan with respect to one or more optimization goals and constraints for the one or more clusters, wherein optimizing the markdown plan comprises performing a mixed integer programming mathematical optimization process with respect to a target function, wherein the target function represents margin penalized by leftover stock; and
generating and storing, using the hardware storage device, an optimized recommended set of markdowns for the one or more clusters.

19. The computer program product of claim 18, wherein clustering the data structures comprises:
determining quantifiable relationships between the one or more products; and
grouping the one or more products into the one or more clusters according to the quantifiable relationships, and according to product information regarding product classes, product categories, and product metrics of the one or more products, wherein the product information is arranged in a vector defined by the product classes, product categories, and product metrics.

20. The computer program product of claim 18, wherein clustering the data structures comprises determining distances between vectors that represent a stock keeping unit, and
wherein the operation further comprise re-optimizing a current discount path for each stock keeping unit of a set of stock keeping units, based on received deviations for the current discount path and received data regarding new sales of the set of stock keeping units.
